(19) United States
(12) Patent Application Publication
(10) Pub. No.: US 2015/0039898 A1
(43) Pub. Date: Feb. 5, 2015

(54) METHOD FOR AUTHENTICATING A DEVICE INCLUDING A PROCESSOR AND A SMART CARD BY PATTERN GENERATION

(71) Applicant: ERCOM ENGINEERING RESEAUX COMMUNICATIONS, VELIZY VILLACOUBLAY (FR)

(72) Inventor: Julien kowalski, Verrieres-Le-Buisson (FR)

(21) Appl. No.: 14/373,901

(22) PCT Filed: Jan. 21, 2013
(86) PCT No.: PCT/EP2013/051048

§ 371 Date: Jul. 22, 2014

(30) Foreign Application Priority Data
Jan. 25, 2012 (FR) 12 50727

(51) Int. Cl. H04L 9/32

(52) U.S. Cl. CPC H04L 9/3226
USPC 713/184

(57) ABSTRACT

A method for authenticating a device comprising a processor and a smart card. A user unlocks the smart card using a PIN code. A secret key Kc of the smart card and the PIN code of the smart card is transmitted to the processor. The processor performs a cryptographic calculation using a secret key Kp of the processor, the PIN code, and Kc. A pattern is generated from the cryptographic calculation by the processor and transmitted to the user. The pattern generated by the device is compared to a pattern memorized by the user.

### FIELD OF THE INVENTION

The present invention relates to the field of Information and Communication Technologies.

The present invention relates more particularly to a method for authenticating a device comprising a processor and a smart card by means of pattern generation.

The present invention concerns a method for enabling a human user to authenticate a hardware element capable of computer calculations (for example a microprocessor). This enables the user to ensure that the hardware unit is actually the intended one and has not been replaced by a copy.

The invention is particularly applicable to mobile telephony, when an attacker impersonates the user's telephone in order to collect sensitive data (recording conversations, data transmitted over the Internet, etc.).

The basic scenario is as follows:
The attacker tries to tap the user's telephone. The current prior art makes it possible to verify the integrity of software (the work of the “Trusted Computing Group”). This verification relies on a so-called trusted hardware device. Any modification of the software, i.e. the tapping of the telephone, will be detected.
However, the case where the attacker impersonates this trusted component is not addressed by the current prior art. Thus, by impersonating this hardware, he is capable of hacking into the software since he controls the entire verification chain. The invention therefore enables a user to detect the impersonation of the trusted hardware.

### PRIOR ART

There are known methods in the prior art for enabling a human being to authenticate a computer hardware device:
The article “Authenticating Pervasive Devices with Human Protocols,” An Juels, Stephen A. Weis.
   Presented at the conference “Advances in Cryptology—CRPYTO'05,”August 2005
   Published in “Lecture Notes in Computer Science Volume 3621, Advances in Cryptology—CRYPTO'05 25^{th} Annual International Cryptology Conference, Santa Barbara, Calif., USA, Aug. 14-18, 2005. Proceedings.” Victor Shoup; pp. 293-308
This article describes the HB and HB+ protocols, which enable a human to authenticate a hardware device without much computational power. These protocols are a series of r exchanges. A fake hardware device has a ½^{r} probability of passing for the real one.
The article “On Authentication between Human and Computer,” Takahiro Watanabe, Yasunobo Nohara, Kensuke Baba, Sozo Inoue, Hiroto Yasuura.
   Presented at the workshop “Fourth Annual IEEE International Conference on Pervasive Computing and Communications Workshop-PerCom Workshop 2006,” March 2006
   Published in the proceedings, “PerCom 2006—Fourth IEEE International Conference on Pervasive Computing and Communications WORKSHOPS,” the IEEE Computer Society; pp. 636-639.
This article proposes an authentication method between a human and a computer. This method uses a third hardware device for the user actual authentication.
The “sign-in seal” method from the American company Yahoo! Inc.

This method enables a human user to verify that he is connected to the right server (which in this case plays the role of the computer hardware to be authenticated). This verification is ensured by the fact that only the real server is capable of reconstituting an image previously saved by the user. The image is only reconstituted for a given machine on which the user makes the request.

The technical problem that the present invention proposes to solve is that of mutually authenticating each of the elements of a system composed of:
A computer hardware device comprising:
   A processor
   Software
A smart card
The user of both the computer hardware device and the smart card.

The solutions of the prior art enable:
The smart card to authenticate the user, using a PIN code;
The software to authenticate the smart card by verifying a secret contained in the card;
The processor to authenticate the software; the work of the “Trusted Computing Group” provides a technical solution that makes it possible to verify the integrity of the software present in a computing platform (personal computer, smartphone, tablet, etc.).

However, a human user has no means of verifying that his hardware has not been impersonated by an adversary for the purpose of collecting sensitive data (personal data, trade secrets, etc.) that belongs to him.

FIG. 1 generally illustrates the authentication problem.

The known prior art includes the PCT application No. WO 00/54126 (Hewlett Packard) describing a smart card user interface for a trusted computing platform.

### DESCRIPTION OF THE INVENTION

The object of the present invention is to overcome the drawbacks of the prior art by proposing a method that enables the user to authenticate his hardware (processor and smart card), i.e. to fill in the missing authentication link (the dashed line in FIG. 1).

The processor must be able to perform cryptographic calculations, and to securely store and use a secret key Kp, meaning that the key must not be exportable outside of the processor. The algorithm used for the cryptographic calculations can be either symmetric or asymmetric.

The smart card must be able to securely store a secret key Kc.

The user has a PIN code that makes it possible to unlock the smart card in order to make the key Kc accessible.

The general principle of the method according to the present invention is the following: the processor will generate a pattern (character string, image, etc.) from the user's secret (PIN code), the card's secret (Kc) and its own secret (Kp). The slightest modification of any of these elements results in a modification of the pattern. The user will be able to authenticate his hardware by verifying the pattern returned.

The present invention relates, in the most general sense, to a method for authenticating a device comprising a processor and a smart card, characterized in that it comprises the following steps:
the unlocking by a user of said smart card using a PIN code;
the transmission of a secret key Kc of said smart card, and of the PIN code of said smart card, to said processor;
a cryptographic calculation in said processor using a secret key Kp of the processor, the PIN code, and Kc;
the generation by said processor of a human-readable pattern from said cryptographic calculation;
the transmission of said pattern to the user; and
a comparison by the user of said pattern generated by the device with a pattern memorized by the user.

The pattern memorized by the user is generated in the same way, but in a secure environment; i.e., at a time when the user is certain that his hardware is authentic.

The method according to the present invention enables the user to authenticate the device. In essence, the method for generating the pattern ensures that only a hardware device using the right key Kp is capable of providing the valid response to the challenge given by the user. The use of the key Kc prevents an attacker from simply requesting the generation of all the possible patterns in order to present them to the user when he enters his PIN code; moreover, the use of the PIN code makes it possible to obtain a different pattern by changing this code should an attacker succeed in compromising the pattern, and also makes it possible to deny access to the key Kc by conditioning it on the entry of this PIN code into the smart card.

According to one embodiment, said pattern is a character string.

According to another embodiment, said pattern is an image.

According to another embodiment, said pattern is a sound or a series of sounds.

According to another embodiment, said pattern is a haptic feedback (a series of vibrations).

According to another embodiment, said pattern is derived from a combination of several modes for generating patterns belonging to the group comprising a character string, an image, a series of sounds, and a haptic feedback (a series of vibrations).

The various types of patterns must therefore not be correlated with each other, meaning that they must be generated from independent parts of the result of the cryptographic calculation.

According to a variant, said cryptographic calculation is a symmetric encryption algorithm.

According to another variant, said cryptographic calculation is a cryptographic hash with key.

According to another variant, said cryptographic calculation is a deterministic asymmetric encryption.

Advantageously, said cryptographic calculation is a hash-based message authentication code (HMAC) type calculation.

According to one embodiment, said pattern is displayed if the user performs an action.

According to a particular embodiment, said action by the user corresponds to said user's pressing on a key for a length of time greater than a predetermined threshold.

Advantageously, said pattern is a character string corresponding to the hexadecimal representation of the result of said cryptographic calculation.

Preferably, said cryptographic calculation is performed in a “trusted zone” of said processor.

According to one embodiment, said pattern is obtained by retaining the first four bytes of the response from the cryptographic calculation represented in hexadecimal form, i.e. eight hexadecimal characters.

According to one embodiment, said image is a fractal image having the response from the cryptographic calculation as its seed.

Furthermore, compared to the prior art solutions described above:
The authentication is achieved with few exchanges between the hardware device and the user, and few calculations on the part of the user, unlike the solution described in the above-cited article “Authenticating Pervasive Devices with Human Protocols”;
This mechanism enables the user to simultaneously authenticate both the processor and the smart card;
Unlike in the solution described in the above-cited article “On Authentication between Human and Computer,” the smart card does not need to perform any calculations or present a trusted interface to the user; and unlike the solution described in the above-cited article “On Authentication between Human and Computer,” this is a standalone solution; the user does not need to trust the cryptographic token (the smart card) used.
Unlike the “sign-in seal” method from the American company Yahoo!

Inc., this is a standalone solution; the Yahoo! solution, in order to be effective, must be used in a secure machine in order to authenticate the remote server. In essence, the compromising of the cookie on the user's machine enables an attacker to retrieve the pattern in the remote server and thus to be capable of displaying it to the user.

### BRIEF DESCRIPTION OF THE DRAWINGS

The invention will be more clearly understood with the help of the purely explanatory description of an embodiment of the invention given below, in reference to the Figures, in which:

FIG. 1 generally illustrates the authentication problem;

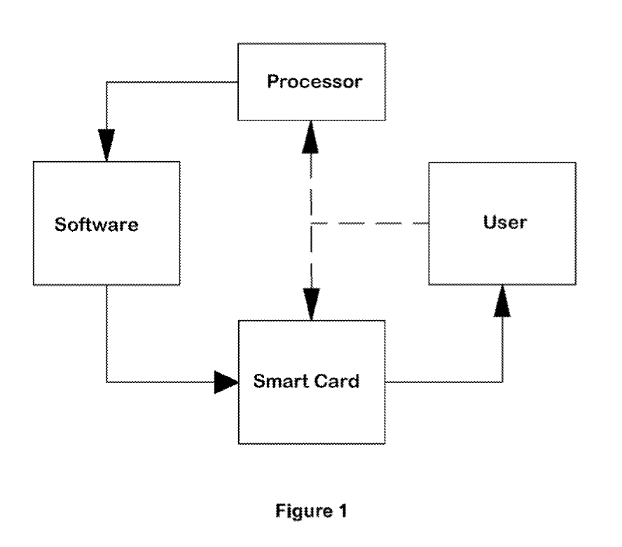

FIG. 2 generally represents the method according to the present invention;

FIG. 3 illustrates examples of patterns; and

FIG. 4 represents one embodiment of the method according to the present invention.

### DETAILED DESCRIPTION OF THE EMBODIMENTS OF THE INVENTION

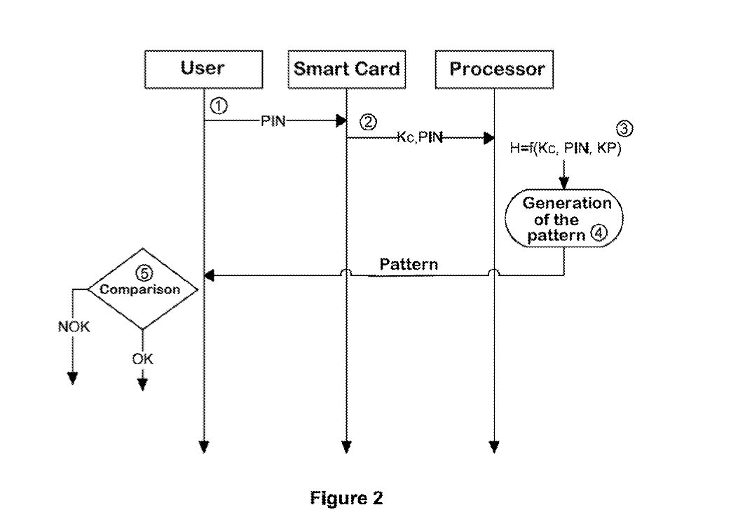

FIG. 2 generally represents the method according to the present invention.

According to the present invention, the method for authenticating a device comprising a processor and a smart card comprises the following steps:
the unlocking by a user of said smart card using a PIN code;
the transmission of a secret key Kc of said smart card, and of the PIN code of said smart card, to said processor;
a cryptographic calculation in said processor using a secret key Kp of the processor, the PIN code, and Kc;
the generation by said processor of a human-readable pattern from said cryptographic calculation;
the transmission of said pattern to the user; and
a comparison by the user of said pattern generated by the device with a pattern memorized by the user.

There are many possible variants related to the cryptographic calculation performed by the processor. Any cryptographic function that generates a pseudorandom response dependent on the key Kp, and that keeps Kp secret, is suitable (AES encryption, hash with key, deterministic asymmetric encryption, etc.). A particularly advantageous embodiment consists in the use of an HMAC-SHA256 calculation in the following way:

HMAC-SHA256[Kp](PIN, Kc)

The step of the method that consists in generating the pattern from the random response also has many variants:
Generating a character string representing this response (hexadecimal display, base64 encoded, etc.)
Generating an image that is a unique representation of this response. For example:
   Generating a fractal image having this response as its seed;
   Using the method provided at the following URL: http://www.thevash.com/
Generating a series of sounds, each note of which represents a few bits of the response;
Etc.

The duration of the display of the pattern can be adjusted to achieve a compromise between convenience and security. In a variant, the pattern can only be displayed if the user requests it by means of a particular action (for example, a long press on the “enter” key).

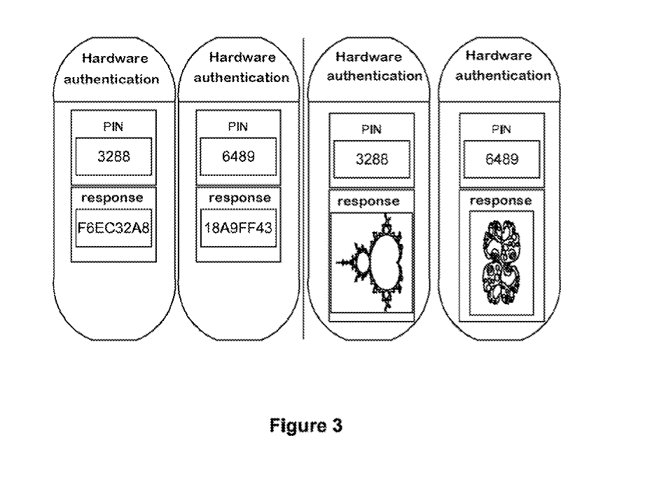

FIG. 3 illustrates examples of patterns. In the two examples on the left, the pattern generated is a character string corresponding to the hexadecimal representation of the result of the cryptographic calculation, which is a particularly advantageous embodiment. In the two examples on the right, the pattern generated is an image.

One anticipated application of the method according to the present invention is an ARM processor implementation. This type of processor has a space known as a “trusted zone” for storing a secret key K. This type of processor is capable of performing calculations involving K without thereby exposing this key.

The following is an embodiment of the method according to the present invention:
The cryptographic calculation performed by a processor is an HMAC-SHA256:
HMAC-SHA256[Kp](Kc, PIN);
This cryptographic calculation is performed in the “trusted zone” of the processor;
The pattern is obtained by retaining the first 4 bytes of the response represented in hexadecimal form, i.e. 8 hexadecimal characters.

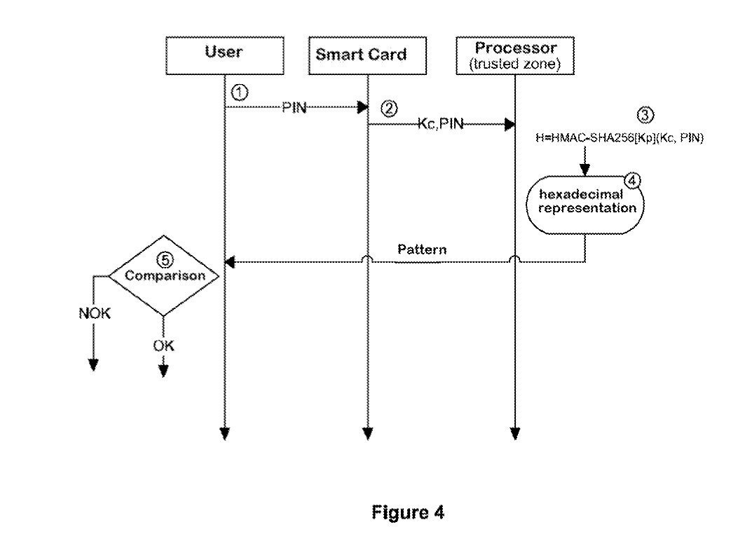

The series of exchanges takes place as shown in FIG. 4.

The fact that the key Kp remains secret and internal to the processor ensures that only the valid processor is capable of generating the pattern corresponding to the pair (PIN, Kc) and stored by the processor itself.

The fact that the key Kc is protected by the smart card (via the PIN code) prevents an attacker from using the processor as a black box in order to generate all of the possible responses for each PIN code in advance.

Thus, an attacker who impersonates:
the processor alone will not be able to fool the user; the key Kp being secret, he will not be able to generate the correct pattern;
the smart card alone will not be able to fool the use; the key Kc being secret since it is protected by the user's PIN code, he will not be able to generate the correct pattern;
the processor and the smart card will not be able to fool the user; the keys Kc and Kp being secret, he will not be able to generate the correct pattern.

The fact that the pattern is generated using a combination of methods involving different senses of the user makes it possible to strengthen security against the risk of compromising the legitimate pattern.

In the case where the pattern comprises:
a visual part (image) and
a sound part (series of sounds) and
a touch part (series of vibrations),
   an attacker who has managed to observe the visual part of the pattern (via a surveillance camera, for example) will not be able to generate a valid pattern: he will be missing the sound and touch parts. This is due to the fact that the different parts of the pattern are generated independently: obtaining one part of the pattern does not make it possible to obtain information on the other parts and thereby reproduce the entire pattern.

The invention is described above only by way of example. It is understood that a person skilled in the art will be capable of producing different variants of the invention without thereby going beyond the scope of the patent.

1-16. (canceled)

17. A method for authenticating a device comprising a processor and a smart card, the method comprising the steps of:
unlocking the smart card using a PIN code by a user;
transmitting a secret key Kc of the smart card and the PIN code of the smart card to the processor;
performing a cryptographic calculation by the processor using a secret key Kp of the processor, the PIN code, and the secret key Kc;
generating a pattern from the cryptographic calculation by the processor;
transmitting the pattern to the user; and
comparing the pattern generated by the device and a memorized pattern by the user.

18. The method according to claim 17, wherein the pattern is a character string.

19. The method according to claim 17, wherein the pattern is an image.

20. The method according to claim 17, wherein the pattern is sound or a series of sounds.

21. The method according to claim 17, wherein the pattern is a haptic feedback or a series of vibrations.

22. The method according to claim 17, wherein the pattern is derived from a combination comprising at least one of: a character string, an image, a series of sounds, and a haptic feedback or a series of vibrations.

23. The method according to 17, wherein the cryptographic calculation is a symmetric encryption algorithm.

24. The method according to claim 17, wherein the cryptographic calculation is a cryptographic hash with key.

25. The method according to claim 17, wherein the cryptographic calculation is a deterministic asymmetric encryption.

26. The method of according claim 17, wherein the cryptographic calculation is a hash-based message authentication code (HMAC) type calculation.

27. The method according to claim 17, further comprising the step of displaying the pattern in response to an action by the user.

28. The method according to claim 17, further comprising the step of displaying the pattern in response to the user pressing on a key for a length of time greater than a predetermined threshold.

29. The method according to claim 17, wherein the pattern is a character string corresponding to a hexadecimal representation of a result of the cryptographic calculation.

30. The method according to claim 17, further comprising the step of performing the cryptographic calculation in a trusted zone of the processor.

31. The method according to claim 29, further comprising the step of obtaining the pattern by retaining first four bytes of a response from the cryptographic calculation represented in hexadecimal form.

32. The method according to claim 19, wherein the image is a fractal image having a response from the cryptographic calculation as its seed.
